(19) United States
(12) Patent Application Publication
(10) Pub. No.: US 2008/0300776 A1
(43) Pub. Date: Dec. 4, 2008

(54) Traffic lane management system

(76) Inventors: Gregory C. Petrisor, Los Angeles, CA (US); Ryan A. Perdue, Venice, CA (US)

Correspondence Address: Scot A. Reader, Suite 228, 1320 Pearl Street, Boulder, CO, 80302, US

(21) Appl. No.: 12/154,701

(22) Filed: May 27, 2008

Related U.S. Application Data
(60) Provisional application No. 60/932,737, filed on Jun. 1, 2007.

(51) Int. Cl. G08G 1/00; G06F 3/048

(52) U.S. Cl. 701/118

(57) ABSTRACT

A management system for a traffic lane achieves congestion management objectives by dynamically predicting future vehicle density in a traffic lane and assigning to a requesting user a time slot for entering the traffic lane selected independent of any user requested time and based at least in part on a current prediction about future vehicle density in the traffic lane. The current prediction is based at least in part on predicted trajectories of vehicles, which are determined in turn based at least in part on actual trajectories of vehicles.

### CROSS-REFERENCE TO RELATED APPLICATION(S)

This application claims priority benefits under 35 U.S.C. 119(e) from U.S. provisional patent application Ser. No. 60/932,737, filed Jun. 1, 2007, entitled “VEHICLE SCHEDULING CONGESTION MANAGEMENT SYSTEM.”

### BACKGROUND OF THE INVENTION

The present invention relates to a management system for a traffic lane, and more particularly to a management system for a traffic lane that achieves congestion management objectives by dynamically predicting future vehicle density in the traffic lane and assigning to a requesting user a time slot for entering the traffic lane selected independent of any user requested time and based at least in part on a current prediction about future vehicle density in the traffic lane.

Traffic congestion has become a significant impediment to the quality of life in urban areas. Physical road capacity (lane-miles) of the nation's roadway system has grown slowly over the lost quarter century whereas vehicle miles traveled have grown rapidly over the some period. The United States Department of Transportation (USDOT) has indicated that there are insufficient resources to build additional physical road capacity at a rote to keep up with demand. High costs to add physical road capacity and long timelines for deployment have led to anemic growth in physical road capacity in some urban areas.

USDOT has promoted carpooling as an alternative to adding road capacity. To promote car pooling, USDOT has incentivized states to create high occupancy vehicle (HOV) traffic lanes, more commonly known as carpool lanes, whose lawful usage is typically limited to vehicles with multiple occupants. As a result, most states now have networks of HOV lanes in congested areas. In the peak of rush hour conditions, HOV lanes may at times reach full capacity. However, there is often a significant amount of excess capacity that goes unutilized even during rush hour conditions.

Some states have liberalized access to HOV lanes in order to use some of this excess capacity. For example, California has issued stickers to owners of qualifying hybrid vehicles that allow these vehicles to lawfully access HOV lanes even when carrying a single occupant. This has led to greater utilization of HOV lanes; however, in congested areas it has adversely impacted carpoolers.

Additionally, several variants of high occupancy tolling (HOT lane tolling) have been proposed or deployed that allow utilization of excess HOV lane capacity by single occupant vehicles on a charge basis. These systems have generally called for installation of radio frequency identification (RFID) tags in single occupant vehicles and the deployment of periodic gantries along the road with signage that announces current toll rates. RFID readers in the gantries read the RFID tags in passing vehicles and charge the single occupant for use of the HOV lane, monitor current congestion, and dynamically adjust HOV lane toll rates for single occupant vehicles in response to current congestion. However, the “tolling” aspect of HOT lane tolling is often politically unpopular and has proven a serious drawback. Some people object to HOT lane tolling systems because they have developed an expectation that they will not have to pay tolls to use certain roads. Others object to the fact that a certain segment of the population cannot afford the tolls. Even where the political obstacles to installation of HOT lane tolling systems hove been overcome and such systems have been deployed, resistance to the tolls has sometimes led to underutilization of such systems and resulted in a failure to achieve congestion management objectives.

Meanwhile, it is known that traffic flow depends heavily on vehicle density. FIG. 1 depicts an exemplary speed-flow relationship under clear weather conditions that illustrates the significant benefits achieved when operating at free-flow. In the “Free-Flow with Margin” region, vehicle speeds of 65-75 miles per hour (MPH) are achieved at a flow rate of 2,000 vehicles per lane per hour. In this region, vehicles are operating at high efficiency and lanes are operating near capacity. As the flow rote approaches 2,500 vehicles per lane per hour, however, the “Unstable” region is entered and traffic conditions can dramatically deteriorate. Harsh braking by a single vehicle can significantly alter flow dynamics and quickly reduce free-flow traffic to stop-and-go traffic. In that event, vehicles enter the “Forced Flow” region where the average vehicle speed decreases to roughly 30 MPH and the flow rate drops to 1,000 vehicles per lane per hour. This is typical of rush hour conditions where overall throughput is dramatically reduced and commute times increase dramatically.

### SUMMARY OF THE INVENTION

The present invention, in a basic feature, provides a management system for a traffic lane that achieves congestion management objectives by dynamically predicting future vehicle density in a traffic lane and assigning to a requesting user a time slot for entering the traffic lane selected independent of any user requested time and based at least in part on a current prediction about future vehicle density in the traffic lane.

In one aspect of the invention, a management system for a traffic lane comprises a user interface and a control system communicatively coupled with the user interface, wherein the control system dynamically predicts future vehicle density in the traffic lane and in response to a request input by a user on the user interface offers to the user via the user interface a time slot for a vehicle to enter the traffic lane selected by the control system independent of any time requested by the user and based at least in port on a current prediction of future vehicle density in the traffic lane.

In some embodiments, the time slot is the first available time slot.

In some embodiments, the management system further comprises a detection system communicatively coupled with the control system, wherein the control system dynamically predicts future vehicle density based at least in part on information collected by the detection system.

In some embodiments, the information collected by the detection system comprises at least one of radio navigation satellite system (RNSS) information, contactless identification system information, inductive-loop system information, vision-based system information or radar-based system information.

In some embodiments, the control system dynamically predicts future vehicle density based at least in part on predicted trajectories of vehicles.

In some embodiments, the control system determines the predicted trajectories based at least in part on measured trajectories of vehicles.

In some embodiments, the request comprises an identification of the user.

In some embodiments, the request comprises an identification of the vehicle.

In some embodiments, the request comprises an identification of an entry point and an exit point from the traffic lane.

In some embodiments, the request comprises an identification of a trip origination point and destination point from which the control system identifies an entry point and an exit point from the traffic lane.

In some embodiments, the control system compares the current prediction of future vehicle density with a predetermined vehicle density threshold and offers the time slot in response to a determination that the predicted vehicle density does not exceed the predetermined vehicle density threshold.

In some embodiments, the control system compares the current prediction of future vehicle density with a predetermined paid vehicle density threshold that is higher than a predetermined unpaid vehicle threshold and offers the time slot for a fee in response to a determination that the predicted vehicle density does not exceed the predetermined paid vehicle density threshold.

In some embodiments, the user inputs on the user interface an acceptance of the time slot.

In some embodiments, the control system imposes a fee upon the user if after the acceptance the vehicle fails to enter the traffic lane during the time slot.

In some embodiments, the control system deems the time slot rejected if the user foils within a predetermined time less than fifteen seconds after the offer to input on the user interface an acceptance of the time slot.

In some embodiments, the time slot is selected further based at least in part on a location of the vehicle.

In some embodiments, the user interface is integral to one of a telephone, a personal computer or the vehicle.

In another aspect of the invention, a method for management of a traffic lane comprises the steps of dynamically predicting future vehicle density in the traffic lane, assigning in response to a request made by a user a time slot for a vehicle to enter the traffic lane selected independent of any user requested time and based at least in part on a current prediction of future vehicle density in the traffic lane and offering the time slot to the user.

In some embodiments, the future vehicle density in the traffic lane is dynamically predicted based at least in part on predicted trajectories of vehicles.

In some embodiments, the predicted trajectories of vehicles are determined based at least in part on measured trajectories of vehicles.

In some embodiments, the measured trajectories of vehicles are determined based at least in part on position information provided by the vehicles.

These and other aspects of the invention will be better understood by reference to the following detailed description taken in conjunction with the drawings that are briefly described below. Of course, the invention is defined by the appended claims.

### BRIEF DESCRIPTION OF THE DRAWINGS

FIG. 1 shows an exemplary speed-flow relationship under clear weather conditions.

FIG. 2 shows a management system for a traffic lane in some embodiments of the invention.

FIG. 3 shows current predictions of future vehicle density between an entry point and an exit point of a traffic lane for different entry times.

FIG. 4 shows a traffic lane access request form rendered on a user interface in some embodiments of the invention.

FIG. 5 shows a traffic lane access offer form rendered on a user interface in some embodiments of the invention.

FIG. 6 shows a method for management of a traffic lane in some embodiments of the invention.

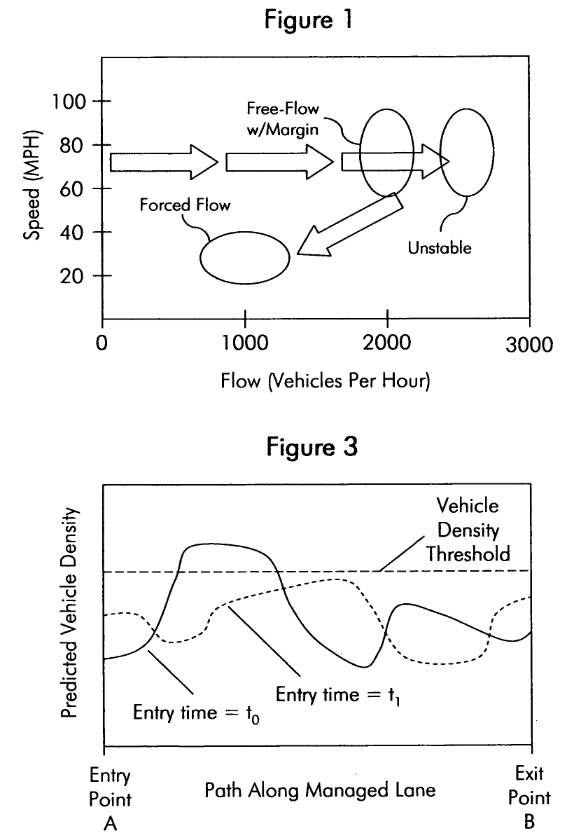

### DETAILED DESCRIPTION OF A PREFERRED EMBODIMENT

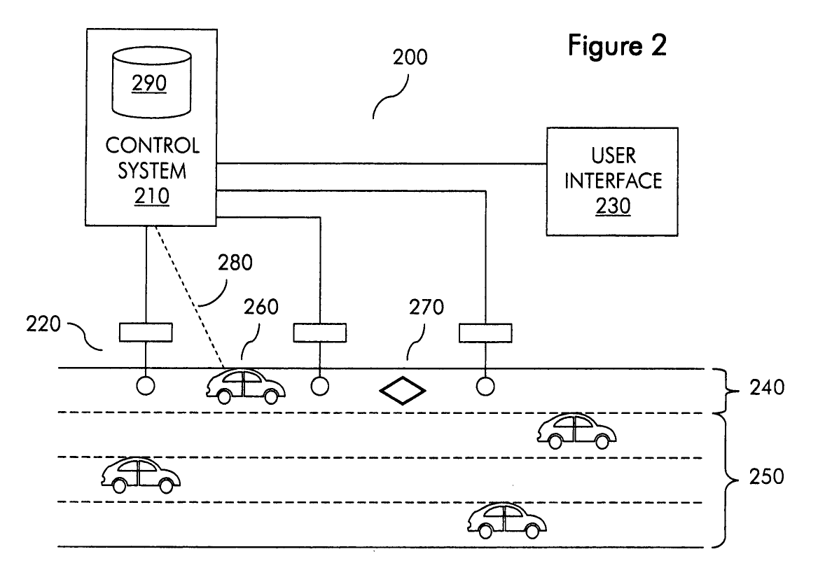

FIG. 2 shows a management system 200 for a traffic lane in some embodiments of the invention. Management system 200 manages a managed traffic lane 240 of a road having managed lane 240 as well as unmanaged traffic lanes 250. In other embodiments of the invention, a management system may manage multiple or all lanes of a given road. Unmanaged lanes 250 can be lawfully used by all vehicles at all times when unmanaged lanes 250 are in service. Managed lane 240 can be lawfully used only by vehicles that are presently authorized to use managed lane 240. Authorized times for at least some vehicles to use managed lane 240, hereinafter “regulated vehicles, are assigned by management system 200 based on a current prediction about future vehicle density in managed lane 240. Managed lane 240 has markings (e.g. 270) to help drivers of vehicles (e.g. 260) identify managed lane 240 as managed.

Management system 200 includes a control system 210, a detection system 220 and a user interface 230. Detection system 220 continually collects vehicle density information for managed lane 240 and transmits the vehicle density information to control system 210. Detection system 220 includes an inductive loop, optical and/or radar detection system having detectors distributed along managed lane 240 for providing information on traffic flow in managed lane 240. Detection system 220 also includes a RNSS detection system [for example, a global positioning system (GPS) detection system] for providing information on the trip status of individual regulated vehicles (e.g. vehicle 260) that have accepted a time slot to use managed lane 240. The RNSS detection system includes on-board equipment installed on regulated vehicles that acquires RNSS signals from RNSS satellites and transmits RNSS position and time information, along with vehicle identification information, to control system 210 via wireless communication links (e.g. wireless communication link 280). RNSS position and time information may be sent periodically before and/or after a regulated vehicle has entered managed lane 240. In some embodiments, a contactless identification detection system (for example, an RFID detection system) or vision-based detection system may replace or supplement the RNSS detection system and provide position and time information for regulated vehicles.

Control system 210 dynamically predicts future vehicle density in managed lane 240 based on information that is continually supplied by detection system 220. Control system 210 hosts and executes a managed lane control application for making such dynamic predictions. In some embodiments, control system 210 resides in a network operation center remote from managed lane 240 and manages multiple managed lanes based on information received from multiple detection systems. In making predictions for managed lane 240, control system 210 predicts a trajectory along managed lane 240 for every regulated vehicle based on position and time information received from each regulated vehicle. Whenever new position and time information is received from a regulated vehicle, control system 210 compares that actual position and time with an expected position and time determined from an earlier predicted trajectory for the regulated vehicle. If the actual position and time deviates from the expected position and time by more than a predetermined amount, control system 210 re-calculates the predicted trajectory of the regulated vehicle. Control system 210 aggregates the projected trajectories of all regulated vehicles and utilizes it along with aggregate traffic flow data provided by the detection system in order to make a current prediction of future vehicle density in managed lane 240. When predicting future vehicle density, control system 210 incorporates aggregate traffic flow data provided by the detection system in order to account for unregulated vehicles (e.g. high occupancy, hybrid and emergency vehicles) that share managed lane 240 with regulated vehicles but do not provide individual position and time information to control system 210. Predictions of future vehicle density may be specified in terms of estimates, probabilities or confidence intervals.

Control system 210 has a data structure 290 for storing and retrieving position and time information received from regulated vehicles, traffic flow data received from the detection system and current predictions of future vehicle density computed based on the position and time information and traffic flow data.

Control system 210 applies current predictions of future vehicle density in managed lane 240 to judiciously offer time slots for entering managed lane 240 to requesting users. Offered time slots are selected independent of user requested times and are based at least in part on current prediction of future vehicle density in the traffic lane. Preventing users from reserving specific time slots limits undesirable “gaming” of the management system by strategic or malicious users.

A user who wants a time slot first authenticates to control system 210 and then submits a request using user interface 230 that is transmitted to control system 210. User interface 230 may be integral to one of a telephone, a personal computer or a vehicle. The request includes user identification information (e.g. a username), vehicle identification information (e.g. license plate number) and trip information. The trip information includes road identification information (e.g. freeway number and travel direction) and managed lane entry and exit point information (e.g. freeway on-ramp and off-ramp name or number). Control system 210 compares the request with the current prediction of vehicle density and determines the first available time slot that matches the trip information, which it then offers to the user on user interface 230.

Exemplary request processing will now be described by reference to FIG. 3, which shows current predictions of future vehicle density between an entry point A and an exit point B on managed lane 240 for two entry times: t₀ and t₁. Time t₀ may be the current time. Initially, control system 210 receives a request from a user indicating that the user wishes to drive his or her vehicle onto managed lane 240 at entry point A and exit managed lane 240 at exit point B. Control system 210 first retrieves from data structure 290 a current prediction of vehicle density between entry point A and exit point B for a trip starting at entry time to and compares this prediction with a predetermined vehicle density threshold. The threshold may correspond, for example, to a known free-flow with margin vehicle density for managed lane 240 at which vehicles can operate at high efficiency while managed lane 240 is near capacity. Since this prediction of vehicle density exceeds the threshold during part of the trip between entry point A and exit point B, control system 210 declines to offer a time slot that includes entry time t₀ to the user. Control system 210 next retrieves from data structure 290 a current prediction of vehicle density between entry point A and exit point B for a trip starting at a later entry time t₁, which is an incremental time after t₀, and compares this prediction with the predetermined vehicle density threshold. Since this prediction of vehicle density does not exceed the threshold during any part of the trip between entry point A and exit point B, control system 210 offers a time slot that includes entry time t₁ to the user. The time slot offered to the user may be expanded to include a time envelope surrounding the acceptable entry time (e.g. t₁), for example, a number of minutes before and/or after the acceptable entry time.

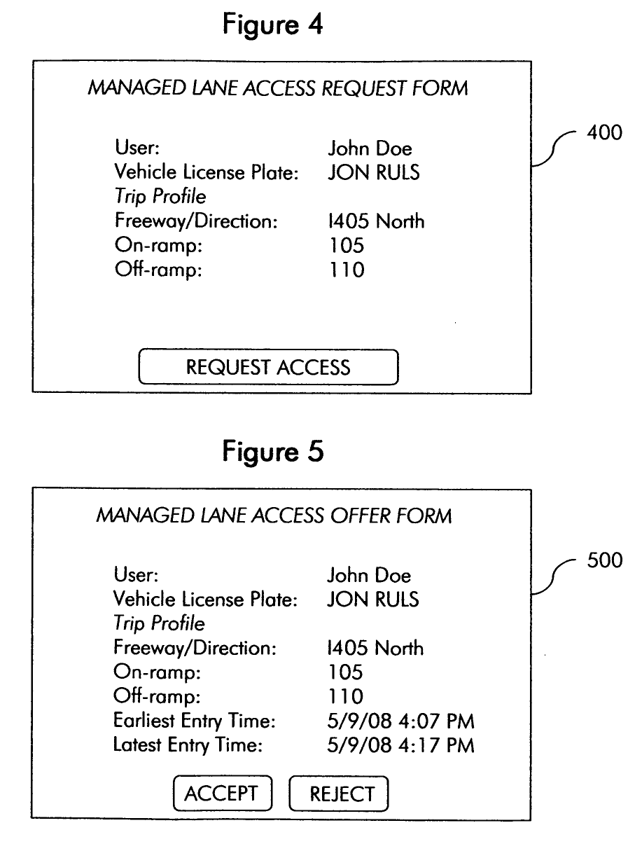

FIG. 4 shows a traffic lane access request form 400 rendered on user interface 230 in some embodiments of the invention. Request form 400 is presented on user interface 230 after a user successfully logs-in to control system 210. After completion, request form 400 includes a username (John Doe) a vehicle license plate (JON RULS) and a trip profile for a requested trip. The trip profile identifies a freeway and direction (Interstate 405 northbound), an on-ramp (number 105), and an off-ramp (number 410) that is being requested by the user. As an alternative to supplying an on-ramp and off-ramp, the request may comprise an identification of a trip origination point and destination point from which control system 210 identifies an entry point and an exit point from traffic lane 240. Once the user is satisfied with the content of form 400, the user clicks the “REQUEST ACCESS” button and a request including content of form 400 is submitted to control system 210.

FIG. 5 shows a traffic lane access offer form 500 rendered on user interface 130 in some embodiments of the invention. Offer form 500 is presented on user interface 230 after processing by control system 210 of a request submitted by a user. Offer form 500 includes a username (John Doe) a vehicle license plate (JON RULS) and a trip profile for an offered trip. The trip profile identifies a freeway and direction (Interstate 405 northbound), an on-ramp (number 105), an off-ramp (number 410) and a time slot for entering managed lane 240 (between 4:07 and 4:17 p.m. on May 9, 2008) that is being offered to the user. The user can either accept the time slot by clicking the “ACCEPT” button or reject the time slot by clicking the “REJECT” button. Upon such user action, the acceptance or rejection is communicated to control system 210. Additionally, control system 210 deems the time slot rejected if the user fails within a predetermined time less than fifteen seconds after the offer to input on the user interface an acceptance of the time slot.

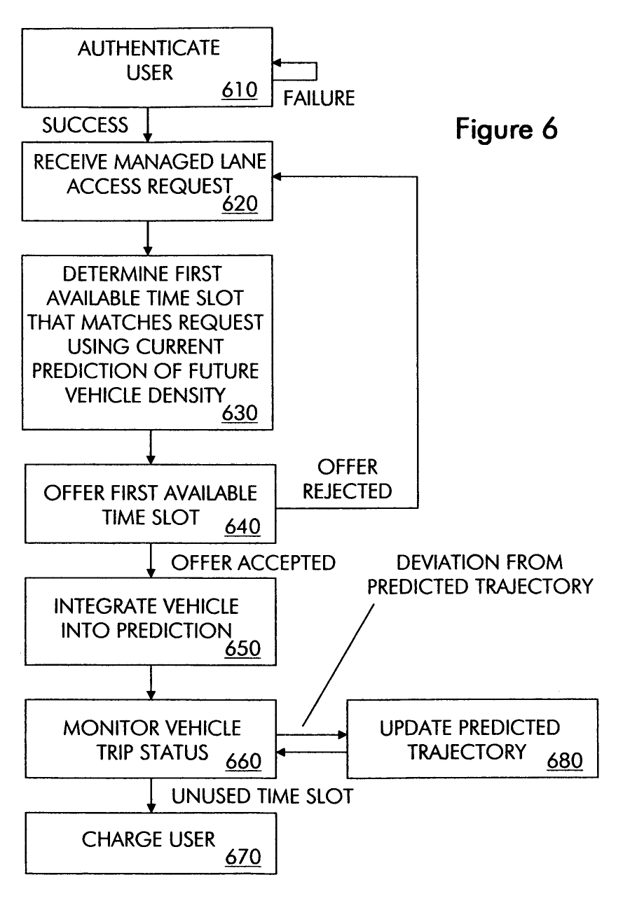

FIG. 6 shows a method for management of a traffic lane in some embodiments of the invention. A user logs-in to control system 210 from user interface 230 (610). If the login fails, the user must reattempt the login in order to access control system 210. If the login succeeds, control system 210 transmits a traffic lane access request form to user interface 230, whereupon the user completes the form and submits a request to control system 210 (620). Control system 210 processes the request and determines the first available time slot that matches the request based on an analysis of current predictions of future vehicle density in managed lane 240 (630). Control system 210 transmits a traffic lane access offer form to user interface 230 identifying the time slot (640). The user may reject the offered time slot by communicating an access rejection to control system 210, in which case the flow returns to Step 620. Alternatively, the user may accept the offered time slot, in which case control system 210 determines an initial predicted trajectory of the user's vehicle along managed lane 240 and re-computes the current prediction of future vehicle density that incorporates the user's vehicle (650). Control system 210 thereafter monitors the trip status of the vehicle by receiving from the vehicle position and time information (660) and updates the predicted trajectory of the vehicle and current prediction of future vehicle density in managed lane 240 as required (670). Control system 210 also monitors to ensure that the vehicle uses the accepted time slot and, if not, charges the user (670).

It will be appreciated by those of ordinary skill in the art that the invention can be embodied in other specific forms without departing from the spirit or essential character hereof. For example, fee-based embodiments may be implemented in which the user can pay for preferential access to managed lane 240. In some of these embodiments, a control system compares the current prediction of future vehicle density with a predetermined paid vehicle density threshold that is higher than the predetermined unpaid vehicle threshold and offers a time slot to a user for a fee in response to a determination that the prediction of future vehicle density does not exceed the predetermined paid vehicle density threshold. Moreover, an offered time slot may be selected based on considerations beyond current predictions of future vehicle density in managed lane 240, such as the location when the time slot is selected of the vehicle that will enter managed lane 240. The vehicle location may be taken into account, for example, to avoid assigning a time slot to a vehicle that would be too remote from the entry point on managed lane 240 to use the time slot. The present description is therefore considered in oil respects to be illustrative and not restrictive. The scope of the invention is indicated by the appended claims, and all changes that come within the meaning and range of equivalents thereof are intended to be embraced therein.

What is claimed is:

1. A management system for a traffic lane, comprising:
a user interface; and
a control system communicatively coupled with the user interface, wherein the control system dynamically predicts future vehicle density in the traffic lane and in response to a request input by a user on the user interface offers to the user via the user interface a time slot for a vehicle to enter the traffic lane selected by the control system independent of any time requested by the user and based at least in port on a current prediction of future vehicle density in the traffic lane.

2. The management system of claim 1, wherein the time slot is the first available time slot.

3. The management system of claim 1, further comprising a detection system communicatively coupled with the control system, wherein the control system dynamically predicts future vehicle density based at least in part on information collected by the detection system.

4. The management system of claim 1, wherein the information collected by the detection system comprises at least one of radio navigation satellite system (RNSS) information, contactless identification system information, inductive-loop system information, vision-based system information or radar-based system information.

5. The management system of claim 1, wherein the control system dynamically predicts future vehicle density based at least in part on predicted trajectories of vehicles.

6. The management system of claim 1, wherein the control system determines the predicted trajectories based at least in part on measured trajectories of vehicles.

7. The management system of claim 1, wherein the request comprises an identification of the user.

8. The management system of claim 1, wherein the request comprises an identification of the vehicle.

9. The management system of claim 1, wherein the request comprises an identification of an entry point and an exit point from the traffic lane.

10. The management system of claim 1, wherein the request comprises an identification of a trip origination point and destination point from which the control system identifies an entry point and an exit point from the traffic lane.

11. The management system of claim 1, wherein the control system compares the current prediction of future vehicle density with a predetermined vehicle density threshold and offers the time slot in response to a determination that the predicted vehicle density does not exceed the predetermined vehicle density threshold.

12. The management system of claim 1, wherein the control system compares the current prediction of future vehicle density with a predetermined paid vehicle density threshold that is higher than a predetermined unpaid vehicle threshold and offers the time slot for a fee in response to a determination that the predicted vehicle density does not exceed the predetermined paid vehicle density threshold.

13. The management system of claim 1, wherein the user inputs on the user interface an acceptance of the time slot.

14. The management system of claim 13, wherein the control system imposes a fee upon the user if after the acceptance the vehicle fails to enter the traffic lane during the time slot.

15. The management system of claim 1, wherein the control system deems the time slot rejected if the user foils within a predetermined time less than fifteen seconds after the offer to input on the user interface an acceptance of the time slot.

16. The management system of claim 1, wherein the time slot is selected further based at least in part on a location of the vehicle.

17. The management system of claim 1, wherein the user interface is integral to one of a telephone, a personal computer or the vehicle.

18. A method for management of a traffic lane, comprising the steps of:
dynamically predicting future vehicle density in the traffic lane;
assigning in response to a request made by a user a time slot for a vehicle to enter the traffic lane selected independent of any time requested by the user and based at least in part on a current prediction of future vehicle density in the traffic lane; and
offering the time slot to the user.

19. The method of claim 18, wherein the future vehicle density in the traffic lane is dynamically predicted based at least in port on predicted trajectories of vehicles.

20. The method of claim 19, wherein the predicted trajectories of vehicles are determined based at least in part on measured trajectories of vehicles.
